(19) United States
(12) Patent Application Publication
(10) Pub. No.: US 2008/0130938 A1
(43) Pub. Date: Jun. 5, 2008

(54) Recess-and Flush-Mountable Rotatable Sound Box and Systems Comprising Same

(76) Inventor: Chen Chou WAN, (US)

Correspondence Address: BAKER DONELSON BEARMAN CALDWELL & BERKOWITZ, PC, 555 11TH STREET, NW, 6TH FLOOR, WASHINGTON, DC, 20004, US

(21) Appl. No.: 11/772,708

(22) Filed: Jul. 2, 2007

(30) Foreign Application Priority Data
Jun. 28, 2006 (CN) 200610036128.9

(51) Int. Cl. H04R 1/02

(52) U.S. Cl. 381/387

(57) ABSTRACT

The invention discloses a flush type rotatable sound box comprising a body case and the loudspeaker system inside the case. The mentioned body case is flush-mounted in wall or ceiling with a revolving gear joining to them. The sound box of this invention saves space and beautifies the indoor environment. The angle of the sound box can be changed depending on user's listening habit and the requirements of sound field by controlling the revolving gear. When the sound box is not to be used, it can be rotated by 180° with the revolving gear in order to keep it in wall or suspended ceiling and to reveal its back. A lighting devices or decoration may be fixed to the back of the sound box upon user's request.

### FIELD OF THE INVENTION

The invention relates a sound box, especially a rotatable sound box for mounting in a wall or ceiling.

### BACKGROUND OF THE INVENTION

At present, commercially available sound boxes generally include a body case and a loudspeaker system encased therein. These sound boxes are generally separately arranged inside a room at different locations, depending on the user's listening habit or sound field requirements. These sound boxes not only take up considerable interior space, they also are difficult to arrange and may clutter the room and render the room less aesthetic. This condition is especially noticeable for high-power sound boxes due to their bulkiness.

### DESCRIPTION OF THE INVENTION

In order to overcome the disadvantages of the existing technology, the present invention provides a flush-type rotatable sound box, which eliminates the problems of the current sound box that takes up interior space and leads to a disorderly appearance.

The flush-type rotatable sound box comprises a body case and a loudspeaker system encased therein, wherein the body case is flush mountable in a wall or ceiling, and a revolving gear attaching the body case to the wall or the ceiling.

In one embodiment, the revolving gear of the present invention comprises a motor, a gear set and an output shaft. The motor comprises a rotating/driving shaft which is linked to and drives the gear set, and the gear set is coupled to the output shaft which is in turn linked to the body case.

The motor, gear set and output shaft may be contained in a box, referred to as the gear set box.

A suitable gear set may comprise a worm screw, a helical gear, a double-linked gear set and a gear that are linked in sequence. The rotating shaft of the motor is coupled with the worm screw, and the output shaft with the gear.

A lighting device may be provided on the backside of the body case opposite the loudspeaker system.

A decoration may be provided on the backside of the body case opposite to the loudspeaker system.

A rotatable lighting device may be provided on either or both sides of the sound box. For example, a color background light may be provided on one side, and an energy-saving daylight lamp on the other.

The present invention may further comprise a remote control for controlling the above-mentioned motor. The remote control may comprise a CPU circuit, a remote control circuit, a motor drive circuit and loudspeaker switching circuit. The CPU circuit is connected to the remote control circuit, motor drive circuit and loudspeaker switching circuit respectively.

As compared with existing technology, the sound box of the present invention saves space and beautifies the indoor environment. The angle of the sound box can be changed depending on the user's listening habit and the requirements of sound field by controlling the revolving gear. When the sound box is not in use, it can be rotated, e.g. by 180°, with the revolving gear in order to be concealed in a wall or the suspended ceiling, and to reveal its back. A lighting device or suitable decoration may be fixed to the back of the sound box according to the user's preference.

### BRIEF DESCRIPTION OF THE DRAWINGS

FIG. 1 is a schematic diagram of the axial structure of a sound box of the invention.

FIG. 2 is a schematic diagram of a radial structure a sound box of the invention.

FIG. 3 is another schematic diagram of a radial structure a sound box of the invention.

FIG. 4 is another schematic diagram of a radial structure a sound box of the invention.

FIG. 5 is another schematic diagram of a radial structure a sound box of the invention.

FIG. 6 shows an embodiment of a revolving gear of the invention.

FIG. 7 is a block diagram of a circuit of the invention.

### DETAILED DESCRIPTION OF THE INVENTION

A detailed description on the invention is given below in reference to the drawings.

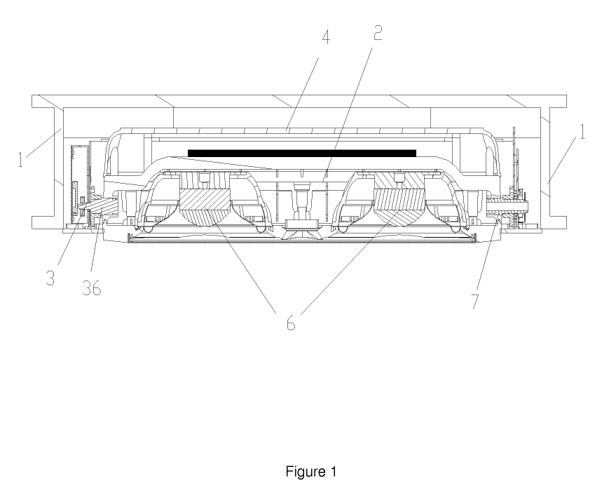

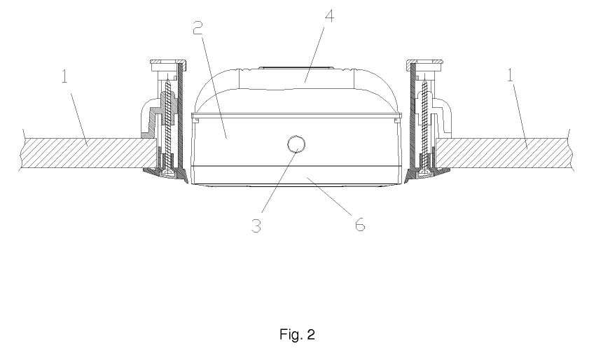

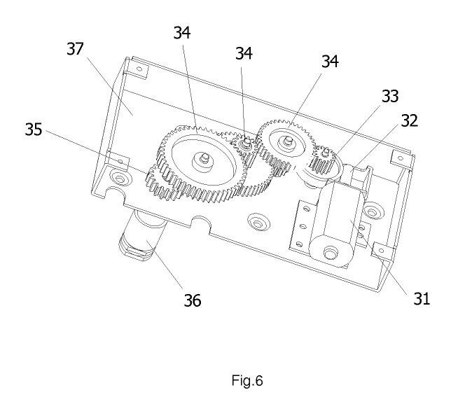

As shown in FIGS. 1, 2 and 6, the flush-mountable and rotatable sound box of the invention is mounted in wall (or ceiling) 1, and comprises body case 2, a speaker system 6 inside the body case 2, and a revolving gear 3. The sound box system may further comprise a remote control (not shown in the drawings). The revolving gear 3 links the left side of the body case 2 with the wall 1. The right side of the body case 2 is linked with the wall 1 through the rotating shaft 7 for balancing and supporting the body case 2. The revolving gear 3 includes motor 31, worm screw 32, helical gear 33, three dual articulated gears/double-linked gear sets 34, gear 35 and output shaft 36. The rotating shaft of motor 31, worm screw 32, helical gear 33, three dual articulated gears 34 and gear 35 are joined or coupled in sequence. The gear 35 joins with the output shaft 36. The output shaft 36 is attached to the body case 2. The rotating shaft of motor 31, worm screw 32, helical gear 33, three dual articulated gears 34, gear 35 and output shaft 36 are fixed in a gear box case 37. A lighting device 4 may be provided on the backside of the body case 2 opposite to the foregoing speaker system 6.

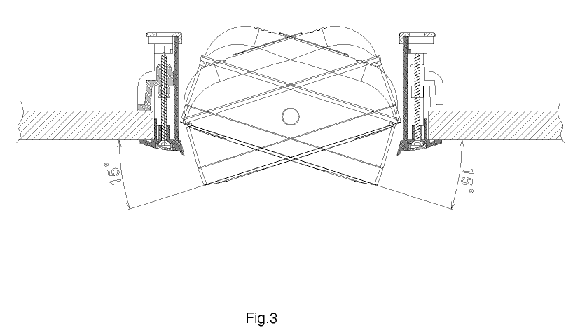

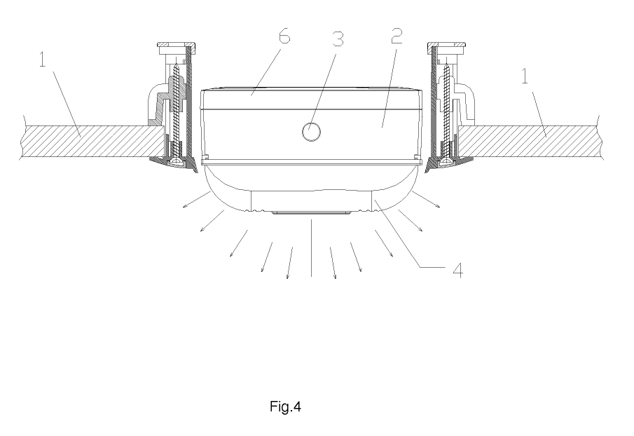

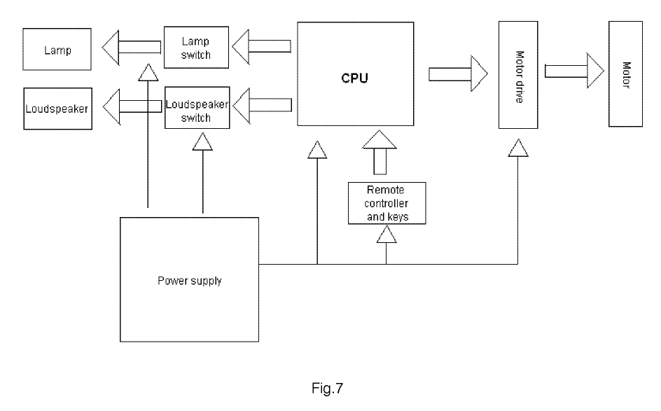

It is possible to activate the motor 31 with a remote control. The motor 31 rotates and drives the sound box to rotate through the worm screw 32, helical gear 33, dual articulated gears 34, gear 35 and output shaft 36 of the flush mounted body case 2. When the sound box turns to an appropriate position, the power supply to the motor can be disconnected with an inductive switch. In this way the angle of rotation as well as the position of the front and rear sides of the sound box can be adjusted as required. To use the sound box, the sound box is rotated by 180° by controlling the revolving gear with the remote controller so as to keep the lighting device on its backside in the wall or ceiling and reveal its front side. At the same time, the sound box automatically switches on the loudspeaker system and switches off the lighting device. In addition, the orientation (angle) of the sound box can be changed during the operation of the loudspeaker system depending on user's listening habit and the requirements of sound field by controlling the remote control (see FIG. 3). As shown in FIG. 4, when the sound box is not in use, it can be rotated again by 180° by controlling the revolving gear with the remote control in order to keep the sound box in the wall or suspended ceiling and to reveal its back. At the same time, the sound box automatically switches off the speaker system and switches on the lighting device if any. It is possible to install an LED lamp or energy-saving fluorescent light on the backside of the sound box as background light source or for lighting at night. It is also possible to attach a decoration (e.g. calligraphy, picture, sculpture and clock) or advertisement to the backside of the sound box depending user's taste and the requirement of the room decoration. In the lighting state of the sound box, the switching of the power supply can be controlled with the remote controller. As shown in FIG. 7, the circuit section corresponding to the abovementioned components comprises a CPU circuit, a remote control circuit, a motor drive circuit, a motor circuit, a lighting switching circuit, a lamp circuit, a loudspeaker switching circuit, a loudspeaker circuit and a power supply circuit. The CPU circuit is connected to the remote control circuit, motor drive circuit, lighting switching circuit, lamp circuit, loudspeaker switching circuit and loudspeaker circuit. The motor drive circuit is connected to the motor circuit. The power supply circuit supplies power to the foregoing circuits.

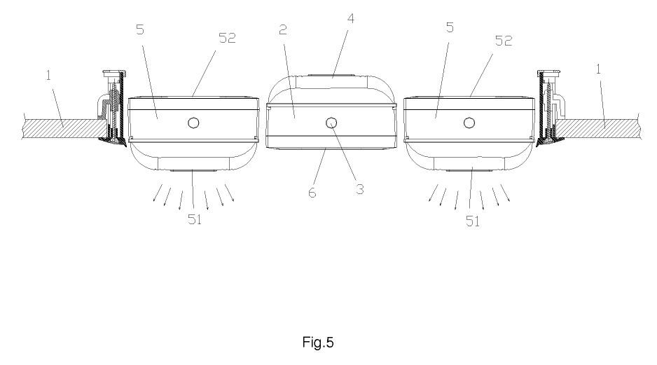

In an alternative embodiment, as shown in FIG. 5, both sides of the sound box are respectively provided with a rotatable lighting device 5 which may comprise tube lamps with different intensities of illumination. One side is a typical energy-saving fluorescent light 51 for illumination and the other a color background light 52 for music background. When the user is not listening to music, he may change the multipurpose sound box to normal lighting state with the remote control. Then the sound box will be automatically disconnected and one rotatable lighting system will change to normal lighting state. To play music, the user may change the multipurpose sound box to loudspeaker state with the remote control. Then the lighting system will be switched off and concealed automatically. At the same time, the other rotatable lighting system may be kept in the existing lighting state without rotation, or rotated to the music background light state. The lighting will be automatically switched off and the background light may flash along with the rhythms of music, thereby creating a pleasant music listening environment.

What is claimed is:

1. A rotatable sound box comprising a body case, a speaker system inside the body case, and a revolving gear connected to the body case, wherein the sound box is flush-mountable in a wall or a ceiling and wherein the revolving gear connecting the body case and the wall or the ceiling.

2. The sound box of claim 1, wherein the revolving gear comprises a motor, a gear set, and an output shaft which is linked to the body case, wherein the motor comprises a rotating shaft which is linked to and drives the gear set, and wherein the gear set is linked to the output shaft.

3. The sound box of claim 2, wherein the motor, gear set and output shaft are contained in a gear box case.

4. The sound box of claim 2, wherein the gear set comprises a worm screw, a helical gear, a dual articulated gear set and a gear that are joined in sequence, wherein the rotating shaft of the motor links up with the worm screw and wherein the output shaft links up with the gear.

5. The sound box of claim 1, wherein a lighting device is provided on the backside of the body case opposite to the speaker system.

6. The sound box of claim 1, wherein a decoration is provided on the backside of the body case opposite to the speaker system.

7. A sound system comprises the rotatable sound box of claim 2, and a remote control for controlling the above-mentioned motor.

8. The sound system of claim 9, comprises an electric circuit which comprises a CPU circuit, a remote control circuit, a motor drive circuit and a speaker switching circuit, wherein the CPU circuit is connected to the remote control circuit, the motor drive circuit and the speaker switching circuit respectively.

9. A rotatable illumination device comprising a rotable sound box and a rotatble lighting device adjacent to the sound box, wherein the rotatable sound box comprising a body case, a speaker system inside the body case, wherein the rotatable lighting device comprises a body case, and wherein the illumination device comprises at least a revolving gear connected to the body case of the sound box or the body case of the lighting device, wherein the illumination device is flush-mountable in a wall or a ceiling and wherein the revolving gear connecting the body case and the wall or the ceiling.

10. The rotatable illumination device of claim 7, wherein two rotatable lighting devices flank the rotatable sound box.

11. The illumination device according to claim 7, wherein the lighting device comprises a color background light on one side, and an illumination lamp on the other.

12. The illumination device according to claim 9, wherein the illumination lamp comprises an energy-saving fluorescent light.

13. A wall or a ceiling of a room, or a portion thereof, comprising a rotatable sound box of claim 1, wherein the sound box is mounted in a flush manner in the wall or ceiling and wherein the revolving gear connecting the body case of the sound box and the wall or the ceiling.
